(19) United States
(12) Patent Application Publication
(10) Pub. No.: US 2026/0279871 A1
(43) Pub. Date: Sep. 17, 2026

(54) FUEL CELL STACK

(71) Applicant: HONDA MOTOR CO., LTD., Tokyo (JP)

(72) Inventors: Tomoki HORI, Saitama (JP); Kazuma HIROE, Saitama (JP); Fumiya ARAI, Saitama (JP); Naoki TANAKA, Saitama (JP)

(21) Appl. No.: 19/541,609

(22) Filed: Feb. 17, 2026

(30) Foreign Application Priority Data
Mar. 12, 2025 (JP) 2025-039718

(51) Int. Cl. H01M 8/2483; H01M 8/04007; H01M 8/04029

(52) U.S. Cl. CPC H01M 8/2483; H01M 8/04029; H01M 8/04074

(57) ABSTRACT

A fuel cell stack includes: a cell stack body; end units disposed at both ends of the cell stack body; and a tube body disposed in a cooling medium discharge flow path to capture and discharge bubbles in cooling medium. One end unit includes an end portion receiving part for receiving an end portion of the tube body. The end portion receiving part includes: a first recessed part that is recessed in a direction away from the cell stack body and is open toward the cell stack body, the first recessed part being provided with a first wall surface that an end surface of the tube body can contact; and a second recessed part that is recessed from a part of the first wall surface in a same direction as the first recessed part, opens in the first wall surface, and communicates with an internal passage of the tube body.

### TECHNICAL FIELD

The present invention relates to a fuel cell stack.

### BACKGROUND ART

In recent years, research and development are being conducted in relation to fuel cells which can contribute to energy efficiency to ensure that a greater number of people can access reliable, sustainable, and advanced energy at reasonable cost.

A fuel cell stack includes a cell stack body composed of a stack of multiple power generation cells. The fuel cell stack is provided with a cooling medium flow path in which a liquid cooling medium (coolant), such as water, for cooling the cell stack body flows in the stacking direction of the cell stack body. The cooling medium flow path includes a cooling medium discharge flow path for discharging the cooling medium that has cooled the fuel cell stack from the fuel cell stack. In such a fuel cell stack, to capture and discharge bubbles generated in the cooling medium discharge flow path to the outside, a tube body, which is often called an air vent tube, may be disposed in the cooling medium discharge flow path (for example, JP2019-79779A).

The air vent tube extends in the cooling medium discharge flow path in the stacking direction of the power generation cells in the cell stack body, and the both ends thereof are supported by end units disposed at end portions of the fuel cell stack. It is preferable for assembly and manufacture that the air vent tube support structure of the end units is configured to be capable of tolerating a stacking error or the like of the power generation cells of the cell stack body. For this reason, the air vent tube is supported by the end units to be displaceable in the radial direction and the longitudinal direction (the stacking direction of the cell stack body) within a range necessary to tolerate the stacking error or the like.

In the fuel cell stack mentioned above, since the air vent tube is supported to be displaceable relative to the end units in the longitudinal direction, the end surfaces of the air vent tube may come into contact with the wall surfaces of the end units. If one end surface of the air vent tube comes into contact with the wall surface of the corresponding end unit, the opening in the end portion of the air vent tube may be closed by the wall surface of the end unit, and the discharge of bubbles by the air vent tube may be hindered.

### SUMMARY OF THE INVENTION

In view of the foregoing background, an object of the present invention is to provide a fuel cell stack in which even when an end surface of the tube body constituting the air vent tube comes into contact with the wall surface of the corresponding end unit, the discharge of bubbles by the air vent tube is not hindered and the bubbles can be discharged. Moreover, the present invention is intended to contribute to energy efficiency.

To achieve the above object, one aspect of the present invention provides a fuel cell stack, comprising: a cell stack body composed of multiple power generation cells stacked in a predetermined direction; a first end unit and a second end unit respectively disposed at both ends of the cell stack body in a stacking direction thereof; a cooling medium flow path including a cooling medium discharge flow path extending through the cell stack body in the stacking direction of the cell stack body to discharge a cooling medium supplied to the cell stack body to an outside; and a tube body disposed in the cooling medium discharge flow path to extend in the stacking direction of the cell stack body, having end portions supported by the first end unit and the second end unit, and including an internal passage having openings at both ends, wherein the second end unit includes an end portion receiving part for receiving a corresponding end portion of the tube body, and the end portion receiving part comprises: a first recessed part that is recessed in a direction away from the cell stack body and is open toward the cell stack body, the first recessed part receiving the corresponding end portion of the tube body to be displaceable in the stacking direction of the cell stack body and a direction perpendicular to the stacking direction and provided with a first wall surface that an end surface of the tube body can contact; and a second recessed part that is recessed from a part of the first wall surface in a same direction as the first recessed part, opens in the first wall surface with an area smaller than an end area of the corresponding end portion of the tube body, and communicates with the internal passage of the tube body.

According to the present invention, even when an end surface of the tube body comes into contact with the wall surface of the corresponding end unit, the discharge of bubbles by the tube body is not hindered and the bubbles can be discharged.

### BRIEF DESCRIPTION OF THE DRAWINGS

FIG. 1 is a perspective view schematically showing an overall configuration of a fuel cell stack according to an embodiment;

FIG. 2 is a vertical sectional view of the fuel cell stack according to the embodiment;

FIG. 3 is an enlarged vertical sectional view of a main part (a part including a dry-side end unit) of the fuel cell stack according to the embodiment;

FIG. 4 is an enlarged sectional view taken along line IV-IV in FIG. 3;

FIG. 5 is an enlarged sectional view taken along line V-V in FIG. 3 (with a tube body);

FIG. 6 is an enlarged sectional view along line V-V in FIG. 3 (without the tube body); and

FIG. 7 is a sectional view similar to the enlarged sectional view taken along line V-V in FIG. 3 and showing a displacement of the tube body relative to the dry-side end unit.

### DETAILED DESCRIPTION OF THE INVENTION

In the following, an embodiment of a fuel cell stack 10 will be described with reference to the drawings. Note that in the following description, three orthogonal axes in the front-rear direction, the left-right direction, and the up-down direction are defined as shown in the drawings.

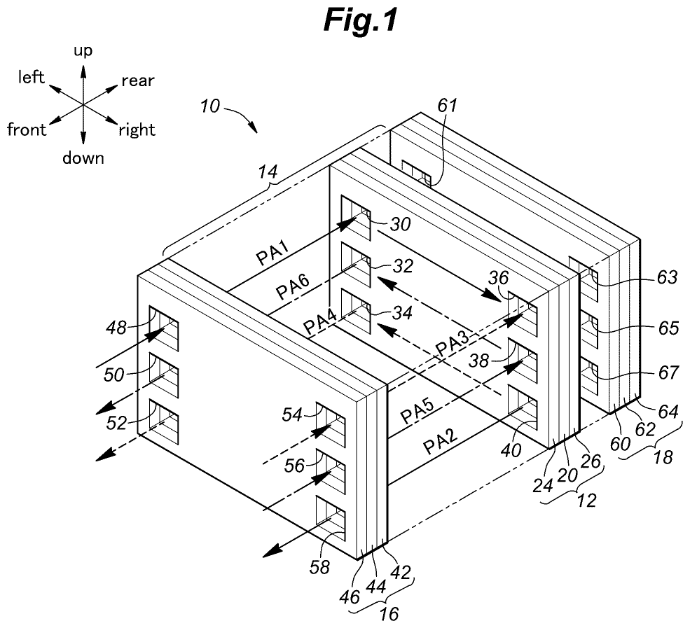

First, an overall structure of the fuel cell stack 10 will be described with reference to FIG. 1. The fuel cell stack 10 includes a cell stack body 14 composed of multiple power generation cells 12 stacked in the front-rear direction (predetermined direction), a wet-side end unit 16 (the first end unit) disposed at one end portion of the cell stack body 14 in the stacking direction, and a dry-side end unit 18 (the second end unit) disposed at the other end portion of the cell stack body 14 in the stacking direction. The wet-side end unit 16 and the dry-side end unit 18 are fastened to the cell stack body 14 in the stacking direction by means of fastening members not shown in the drawings, and they are contained in a stack case not shown in the drawings.

The fuel cell stack 10 is supplied with hydrogen gas (fuel gas) and oxidizer gas (air) as reaction gases.

In the following description, the stacking direction of the cell stack body 14 may be referred to as the front-rear direction.

Each power generation cell 12 includes an electrolyte membrane-electrode structure 20 having a rectangular plate shape, a first separator 24 disposed on one side of the electrolyte membrane-electrode structure 20, and a second separator 26 disposed on the other side of the electrolyte membrane-electrode structure 20. A left edge part of each power generation cell 12 is formed with a hydrogen gas supply opening 30, a coolant discharge opening 32, and an oxidizer gas discharge opening 34 arranged in order from above and each extending through the power generation cell 12 in the stacking direction. A right edge part of each power generation cell 12 is formed with an oxidizer gas supply opening 36, a coolant supply opening 38, and a hydrogen gas discharge opening 40 arranged in order from above and each extending through the power generation cell 12 in the stacking direction.

The wet-side end unit 16 includes a terminal plate 42, an electrical insulation plate 44, and an end plate 46 which are stacked in order from the side of the power generation cells 12. A left edge part of the wet-side end unit 16 is formed with a hydrogen gas supply opening 48, a coolant discharge opening 50, and an oxidizer gas discharge opening 52 arranged in order from above and each extending through the wet-side end unit 16 in the front-rear direction. A right edge part of the wet-side end unit 16 is formed with an oxidizer gas supply opening 54, a coolant supply opening 56, and a hydrogen gas discharge opening 58 arranged in order from above and each extending through the wet-side end unit 16 in the front-rear direction. The openings provided in the wet-side end unit 16 are in the same arrangement as the openings provided in each power generation cell 12 and each communicate with a corresponding one of the hydrogen gas supply opening 30, the hydrogen gas discharge opening 40, the oxidizer gas supply opening 36, the oxidizer gas discharge opening 34, the coolant supply opening 38, and the coolant discharge opening 32 of the power generation cell 12.

The hydrogen gas supply opening 48 communicates with the hydrogen gas supply opening 30 of the power generation cell 12. The coolant discharge opening 50 communicates with the coolant discharge opening 32 of the power generation cell 12. The oxidizer gas discharge opening 52 communicates with the oxidizer gas discharge opening 34 of the power generation cell 12. The oxidizer gas supply opening 54 communicates with the oxidizer gas supply opening 36 of the power generation cell 12. The coolant supply opening 56 communicates with the coolant supply opening 38 of the power generation cell 12. The hydrogen gas discharge opening 58 communicates with the hydrogen gas discharge opening 40 of the power generation cell 12.

The dry-side end unit 18 includes a terminal plate 60, an electrical insulation plate 62, and an end plate 64 which are stacked in order from the side of the power generation cells 12. The terminal plate 60 and the electrical insulation plate 62 are formed with a hydrogen gas supply opening 61, a hydrogen gas discharge opening 67, an oxidizer gas supply opening 63, an oxidizer gas discharge opening (not shown in the drawings), a coolant supply opening 65, and a coolant discharge opening (not shown in the drawings) arranged in the same manner as the openings of the wet-side end unit 16 and each extending through the terminal plate 60 and the electrical insulation plate 62 in the front-rear direction. Note that the end plate 64 is not formed with these openings. The openings provided in the dry-side end unit 18 are in the same arrangement as the openings provided in each power generation cell 12 and each communicate with a corresponding one of the hydrogen gas supply opening 30, the hydrogen gas discharge opening 40, the oxidizer gas supply opening 36, the oxidizer gas discharge opening 34, the coolant supply opening 38, and the coolant discharge opening 32 of the power generation cell 12.

Thereby, the hydrogen gas flows in the stacking direction of the cell stack body 14 through a gas supply flow path PA1 to be supplied to each power generation cell 12. The hydrogen off-gas (exhaust gas) generated at each power generation cell 12 flows from each power generation cell 12 in the stacking direction of the cell stack body 14 through an exhaust gas flow path PA2.

The oxidizer gas may be air and flows in the stacking direction of the cell stack body 14 through a gas supply flow path PA3 to be supplied to each power generation cell 12. The oxidizer off-gas (exhaust gas) generated at each power generation cell 12 flows from each power generation cell 12 in the stacking direction of the cell stack body 14 through an exhaust gas flow path PA4.

The coolant (cooling medium) may be a liquid including water or the like and flows in the stacking direction of the cell stack body 14 through a coolant supply flow path PA5 to be supplied to each power generation cell 12 to cool each power generation cell 12. The coolant discharged from each power generation cell 12 flows in the stacking direction of the cell stack body 14 through a coolant discharge flow path PA6 (cooling medium discharge flow path).

In the fuel cell stack 10, electron and water are generated by the electrochemical reaction of the hydrogen gas and the oxidizer gas supplied to each power generation cell 12, and electric power is taken out from the terminal plates 42 and 60. The water generated in the fuel cell stack 10 is discharged to the outside of the fuel cell stack 10 through the exhaust gas flow paths PA2 and PA4.

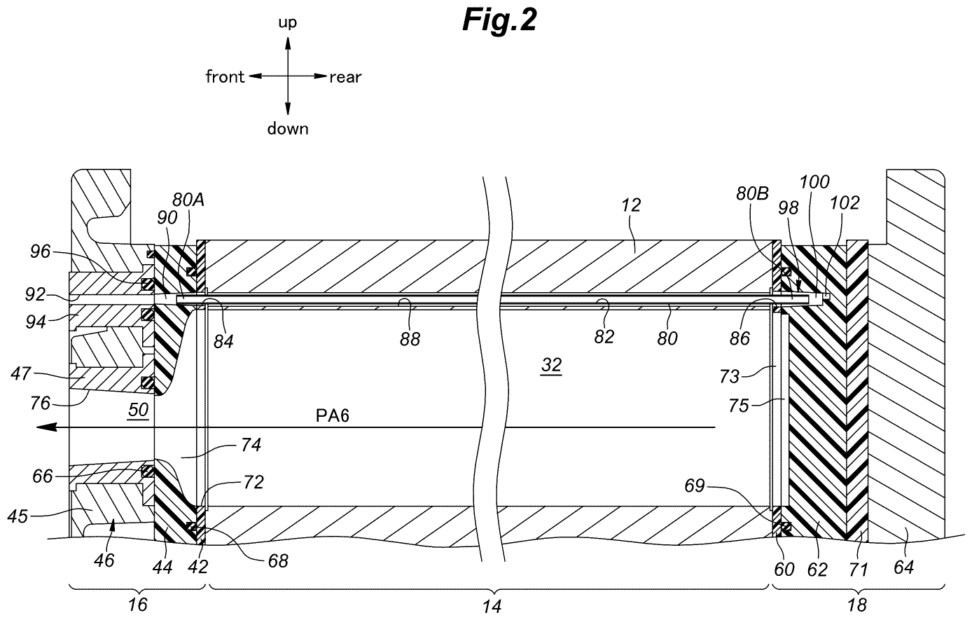

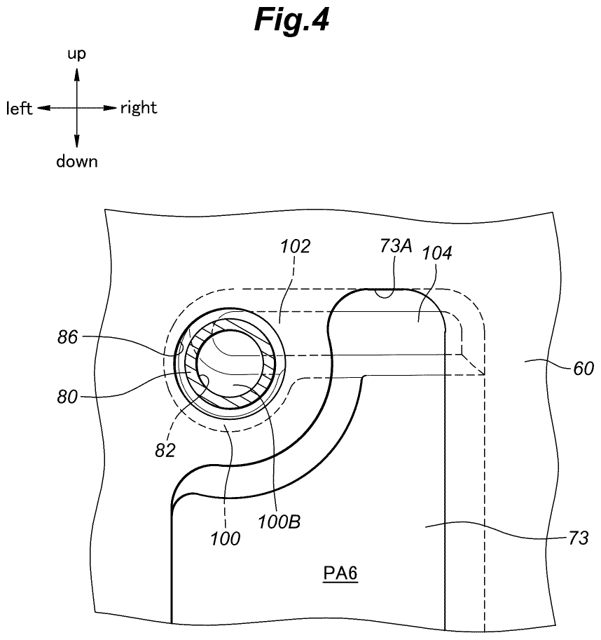

Next, details of the coolant discharge flow path PA6 of the fuel cell stack 10 and the structure related to the coolant discharge flow path PA6 will be described with reference to FIG. 2 to FIG. 7. Note in that FIG. 2 to FIG. 7, elements corresponding to those shown in FIG. 1 are denoted by the same reference signs as in FIG. 1, and the description thereof will be omitted.

As shown in FIG. 2, the end plate 46 of the wet-side end unit 16 includes a port arrangement plate 45 and a port member 47 mounted in the port arrangement plate 45. An airtight seal member 66 is provided between the port member 47 and the electrical insulation plate 44. An airtight seal member 68 is provided between the electrical insulation plate 44 and the terminal plate 42.

The terminal plate 42, the electrical insulation plate 44, and the port member 47 of the wet-side end unit 16 are respectively formed with through holes 72, 74, and 76 which constitute the coolant discharge opening 50.

An airtight seal member 69 is provided between the terminal plate 60 and the electrical insulation plate 62 of the dry-side end unit 18. A gasket 71 is provided between the electrical insulation plate 62 and the end plate 64. The terminal plate 60 of the dry-side end unit 18 is formed with a through hole 73 constituting the coolant discharge opening of the dry-side end unit 18. The electrical insulation plate 62 is formed with a non-through hole 75 constituting the coolant discharge opening of the dry-side end unit 18.

A tube body 80 is disposed in the coolant discharge flow path PA6. The tube body 80 is an air vent tube that captures bubbles in the coolant flowing in the coolant discharge flow path PA6 and discharges the bubbles to the outside. The tube body 80 extends in an upper portion of the coolant discharge flow path PA6 substantially horizontally in the stacking direction of the cell stack body 14, namely, in the front-rear direction. The tube body 80 has a cylindrical shape and includes an internal passage 82 having openings at both ends.

The terminal plate 42 of the wet-side end unit 16 is formed with a support hole 84 to extend therethrough in the stacking direction of the cell stack body 14. The terminal plate 60 of the dry-side end unit 18 is formed with a support hole 86 to extend therethrough in the stacking direction of the cell stack body 14. The front end portion of the tube body 80 extends through the support hole 84 of the terminal plate 42 and thereby is supported by the wet-side end unit 16. The rear end portion of the tube body 80 extends through the support hole 86 of the terminal plate 60 and thereby is supported by the dry-side end unit 18.

A part of the cell stack body 14 constituting an upper side of the coolant discharge opening 32 is formed with a through hole 88 extending therethrough in the stacking direction of the cell stack body 14. The tube body 80 is inserted in the through hole 88 between the wet-side end unit 16 and the dry-side end unit 18. As will be described later, the through hole 88 is connected to the coolant discharge flow path PA6, namely, forms a part of the coolant discharge flow path PA6.

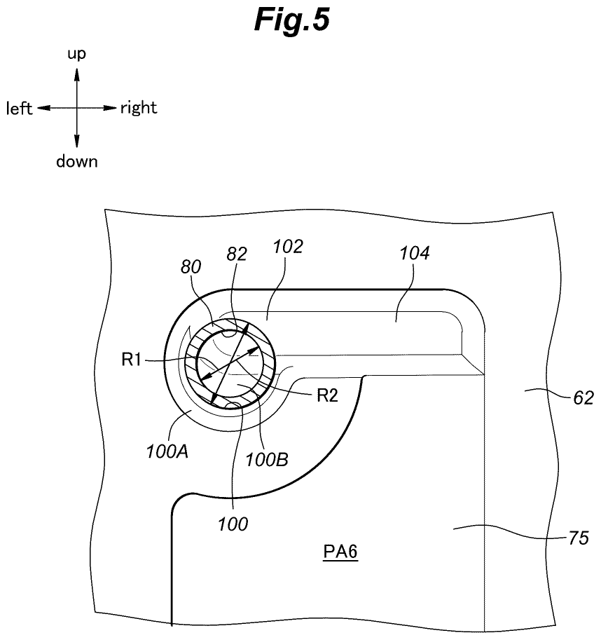

The support holes 84 and 86 and the through hole 88 are arranged on the same axis and have inner diameters greater than the outer diameter R1 of the tube body 80 (see FIG. 5). In other words, the inner diameters of the support holes 84 and 86 and the through hole 88 are greater than the outer shape of the tube body 80 determined by the outer diameter R1. Thereby, the tube body 80 is loosely fitted in the support holes 84 and 86 and the through hole 88 and is displaceable relative to the wet-side end unit 16 and the dry-side end unit 18 in the axial direction and the radial direction.

The electrical insulation plate 44 of the wet-side end unit 16 is formed, as a front end receiving part for receiving the front end 80A of the tube body 80, with a tapered hole 90 to extend therethrough in the stacking direction of the cell stack body 14. The tapered hole 90 is tapered to be narrower toward the end plate 46. A port member 94 having a coolant discharge hole 92 communicating with the tapered hole 90 is mounted in the port arrangement plate 45. An airtight seal member 96 is provided between the port arrangement plate 45 and the port member 94.

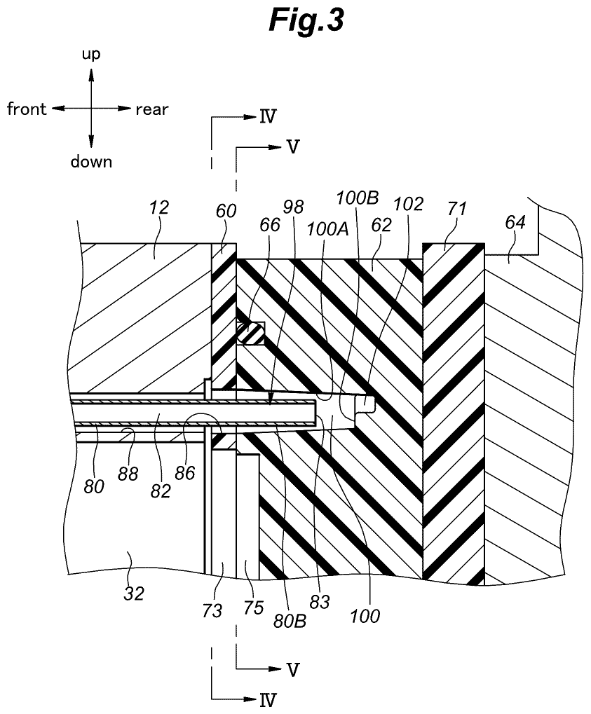

The electrical insulation plate 62 of the dry-side end unit 18 is formed with a rear end receiving part 98. Details of the rear end receiving part 98 will be described with reference to FIG. 3 to FIG. 7.

The rear end receiving part 98 includes a first recessed part 100 and a second recessed part 102.

The first recessed part 100 is recessed in the direction away from the cell stack body 14 (rearward) and is open toward the cell stack body 14 (forward). The first recessed part 100 has a tapered inner peripheral wall surface 100A defining an internal space gradually enlarged in cross section toward the cell stack body 14 and a first wall surface 100B that is flat and extends from a minimum inner diameter end (bottom portion) of the inner peripheral wall surface 100A radially inward in a direction perpendicular to the stacking direction of the cell stack body 14.

The first recessed part 100 has a circular cross-sectional shape on the substantially same axis as the support hole 86 and has a minimum inner diameter greater than the outer diameter R1 of the tube body 80. Thereby, the first recessed part 100 receives the rear end 80B of the tube body 80 in a loose fit manner to be movable in the stacking direction of the cell stack body 14 (the axial direction) and directions perpendicular to the stacking direction of the cell stack body 14 (the radial direction). In other words, the rear end 80B of the tube body 80 can enter the first recessed part 100.

The second recessed part 102 has a part recessed in the same direction as the first recessed part 100 from a substantially upper half of the bottom portion of the first recessed part 100 so as to open in the substantially upper half of the first wall surface 100B with an area smaller than the end area of the rear end portion of the tube body 80, and communicates with the internal passage 82 of the tube body 80. The second recessed part 102 includes a tapered inner peripheral wall surface 102A defining an internal space gradually enlarged in cross section toward the cell stack body 14 and a second wall surface 102B that is flat and extends from a minimum inner diameter end (bottom portion) of the inner peripheral wall surface 102A radially inward in a direction perpendicular to the stacking direction of the cell stack body 14.

Due to the opening of the second recessed part 102, the first wall surface 100B of the first recessed part 100 has a planar shape in a semicircular-crescent shape formed by combining a substantially semicircular shape left in a substantially lower half of the first recessed part 100 and a substantially crescent shape, and a rear end surface 83 of the tube body 80, which has a circular annular shape, can contact the first wall surface 100B. The first wall surface 100B refers to a wall surface in a semicircular-crescent shape shown in the drawings.

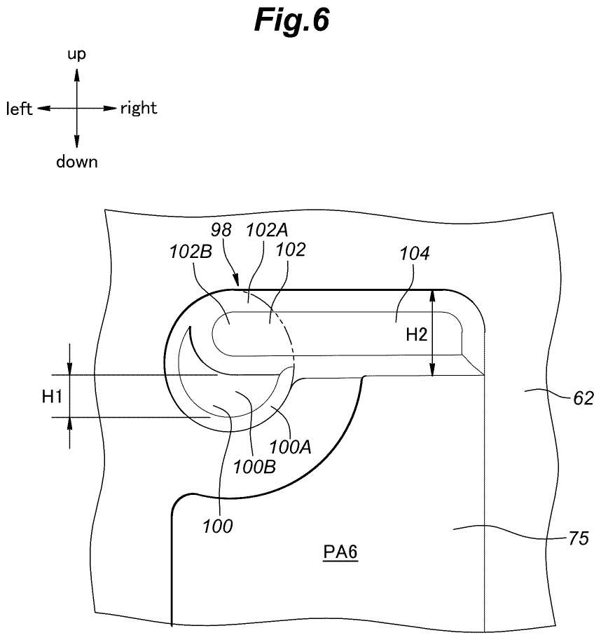

The vertical dimension H1 (FIG. 6) of the first wall surface 100B of the first recessed part 100 is less than the inner diameter R2 (the vertical dimension, FIG. 5) of the internal passage 82. In other words, H1<R2.

The maximum vertical dimension H2 (FIG. 6) of the second recessed part 102 is less than the outer diameter R1 (the vertical dimension, FIG. 5) of the tube body 80. In other words, H2 <R1.

Since the tube body 80, the first wall surface 100B of the first recessed part 100, and the second recessed part 102 have the above arrangement and dimensional relationship, it is ensured that the tube body 80 comes into contact with the first wall surface 100B and the tube body 80 does not enter the second recessed part 102. Also, even if the tube body 80 is displaced relative to the dry-side end unit 18 in the up-down direction, a state in which the second recessed part 102 communicates with the internal passage 82 of the tube body 80, with the tube body 80 contacting the first wall surface 100B can be maintained.

Since the planar shape of the first wall surface 100B is a semicircular-crescent shape formed by combining a substantially semicircular shape and a substantially crescent shape, compared to a case where the planar shape of the first wall surface 100B is a circular shape or the like, it is easier to ensure both that the rear end surface 83 of the tube body 80 comes into contact with the first wall surface 100B of the dry-side end unit 18 and that the inflow of bubbles into the tube body 80 is not hindered by the first wall surface 100B without requiring a large vertical dimension.

The second recessed part 102 includes a side extension part 104 that extends more rightward than a part corresponding to a right outer edge of the first recessed part 100. The side extension part 104 directly communicates with the upper edge of the non-through hole 75 at a lower part thereof. Thereby, the second recessed part 102 communicates with the non-through hole 75 of the electrical insulation plate 44 constituting a part of the coolant discharge flow path PA6 via a relatively large opening, and the bubbles smoothly move from the coolant discharge flow path PA6 to the second recessed part 102 without receiving a large flow resistance.

According to the above configuration, as shown in FIG. 1 to FIG. 3, the bubbles contained in the coolant that is going to flow to the coolant discharge flow path PA6 from the coolant supply flow path PA5 after cooling the cell stack body 14 are captured by and flow into the internal passage 82 of the tube body 80 from the space of the first recessed part 100 and the second recessed part 102 provided in the rear end receiving part 98 of the dry-side end unit 18. These bubbles flow in the internal passage 82 toward the wet-side end unit 16 due to the pressure in the coolant discharge flow path PA6, and further flow through the tapered hole 90 of the wet-side end unit 16 to be discharged from the coolant discharge hole 92 to the outside.

The rearward displacement of the tube body 80 relative to the cell stack body 14 is restricted by the rear end surface 83 of the tube body 80 coming into contact with the first wall surface 100B of the first recessed part 100. Even when the rear end surface 83 of the tube body 80 comes into contact with the first wall surface 100B of the first recessed part 100, the inflow of bubbles into the internal passage 82 of the tube body 80 is allowed by the second recessed part 102 and the discharge of bubbles by the tube body 80 is maintained.

In other words, it is reliably ensured that the rear end surface 83 of the tube body 80 comes into contact with the first wall surface 100B of the dry-side end unit 18 and that the inflow of bubbles into the tube body 80 is not hindered by the first wall surface 100B.

The bubbles have a lower specific gravity than the liquid coolant and gather in an upper portion of the coolant discharge flow path PA6. Since the rear end receiving part 98 of the dry-side end unit 18 is positioned in the upper portion of the coolant discharge flow path PA6, the bubbles gathering in the upper portion of the coolant discharge flow path PA6 flow from the rear end receiving part 98 to the tube body 80. Thereby, the bubbles in the coolant are efficiently captured and discharged by the tube body 80 disposed in the upper portion of the coolant discharge flow path PA6.

In other words, since the rear end receiving part 98 including the first recessed part 100 and the second recessed part 102 is positioned in the upper portion of the coolant discharge flow path PA6, the bubbles in the coolant are favorably captured in the rear end receiving part 98. Also, since the second recessed part 102 is provided in an upper portion of the first recessed part 100, the bubbles are also favorably captured in the second recessed part 102.

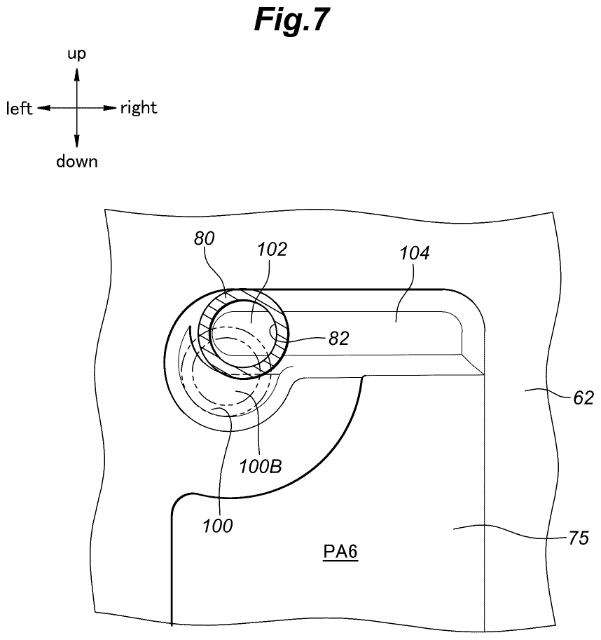

If the tube body 80 is displaced upward or is inclined such that the rear end of the tube body 80 is displaced upward relative to the cell stack body 14, the tube body 80 can contact the inner peripheral wall surface 102A of the second recessed part 102, as shown by a solid line in FIG. 7. In this case also, the rear end surface 83 of the tube body 80 contacts the first wall surface 100B of the first recessed part 100, whereby the tube body 80 does not fall into the second recessed part 102. Moreover, the internal passage 82 is not closed by the first wall surface 100B.

Thereby, even if the rear end surface 83 of the tube body 80 is displaced upward as shown by a solid line in FIG. 7, the communication between the internal passage 82 of the tube body 80 and the non-through hole 75 (the coolant discharge flow path PA6) is maintained by the second recessed part 102, and the bubbles in the coolant are captured and discharged by the tube body 80.

Also, if the tube body 80 is displaced downward or is inclined such that the rear end of the tube body 80 is displaced downward relative to the cell stack body 14, the tube body 80 can contact the inner peripheral wall surface 100A of the first recessed part 100, as shown by a virtual line in FIG. 7. In this case also, the rear end surface 83 contacts the first wall surface 100B of the first recessed part 100, whereby the tube body 80 does not fall into the second recessed part 102. Moreover, the internal passage 82 is not closed by the first wall surface 100B.

Thereby, even if the rear end surface 83 of the tube body 80 is displaced downward as shown by a virtual line in FIG. 7, the communication between the internal passage 82 of the tube body 80 and the non-through hole 75 (the coolant discharge flow path PA6) is maintained by the second recessed part 102, and the bubbles in the coolant are captured and discharged by the tube body 80.

In other words, no matter whether the rear end surface 83 of the tube body 80 is displaced upward or downward, it is reliably ensured that the rear end surface 83 of the tube body 80 comes into contact with the first wall surface 100B of the dry-side end unit 18 and that the inflow of bubbles into the tube body 80 is not hindered by the first wall surface 100B.

The embodiments may be modified in various ways without being limited to the above-described configurations. The planar shape of the first wall surface 100B of the first recessed part 100 is not limited to the semicircular-crescent shape shown in the drawings or a shape similar thereto and may be a semicircular shape, a crescent shape, or other shapes including the center of the first recessed part 100.

The inner peripheral wall surface 100A of the first recessed part 100 and the inner peripheral wall surface 102A of the second recessed part 102 may be straight surfaces.

The above embodiments may be summarized as follows.

One embodiment is a fuel cell stack 10, comprising: a cell stack body 14 composed of multiple power generation cells 12 stacked in a predetermined direction; a wet-side end unit 16 (the first end unit) and a dry-side end unit 18 (the second end unit) respectively disposed at both ends of the cell stack body 14 in the stacking direction thereof; a cooling medium flow path including a coolant discharge flow path PA6 extending through the cell stack body 14 in the stacking direction of the cell stack body 14 to discharge a cooling medium supplied to the cell stack body 14 to an outside; and a tube body 80 disposed in the coolant discharge flow path PA6 to extend in the stacking direction, having a front end 80A (end portion) and a rear end 80B (end portion) supported by the wet-side end unit 16 and the dry-side end unit 18, and including an internal passage 82 having openings at both ends, wherein the dry-side end unit 18 includes a rear end receiving part 98 (end portion receiving part) for receiving an end portion of the tube body 80 on the side of the dry-side end unit 18, and the rear end receiving part 98 comprises: a first recessed part 100 that is recessed in a direction away from the cell stack body 14 and is open toward the cell stack body 14, the first recessed part 100 receiving the rear end 80B (end portion) of the tube body 80 to be displaceable in the stacking direction of the cell stack body 14 and a direction perpendicular to the stacking direction and provided with a first wall surface 100B that the rear end surface 83 (end surface) of the tube body 80 can contact; and a second recessed part 102 that is recessed from a part of the first wall surface 100B in a same direction as the first recessed part 100, opens in the first wall surface 100B with an area smaller than an end area of the rear end 80B (end portion) of the tube body 80, and communicates with the internal passage 82 of the tube body 80.

According to this aspect, even when the rear end surface 83 of the tube body 80 comes into contact with the first wall surface 100B of the dry-side end unit 18, the inflow of bubbles into the tube body 80 is not hindered, and the discharge of bubbles by the tube body 80 is maintained.

In the above aspect, preferably, the vertical dimension H1 of the first wall surface 100B is less than the inner diameter R2 (vertical dimension) of the internal passage 82, and the vertical dimension H2 of the second recessed part 102 is less than the outer diameter R1 (vertical dimension) of the tube body 80.

According to this aspect, even when the tube body 80 is displaced relative to the dry-side end unit 18 in the up-down direction, it is reliably ensured that the rear end surface 83 of the tube body 80 comes into contact with the first wall surface 100B of the dry-side end unit 18 and that the inflow of bubbles into the tube body 80 is not hindered by the first wall surface 100B.

In the above aspect, preferably, the second recessed part 102 is provided in an upper portion of the first recessed part 100.

According to this aspect, the bubbles are favorably captured in the second recessed part 102.

In the above aspect, preferably, the tube body 80 has a cylindrical shape, and the first wall surface 100B has a planar shape that is substantially semicircular or substantially crescent-shaped in a substantially lower half of the first recessed part 100.

According to this aspect, it is ensured that the rear end surface 83 of the tube body 80 comes into contact with the first wall surface 100B of the dry-side end unit 18 and that the inflow of bubbles into the tube body 80 is not hindered by the first wall surface 100B without requiring a large vertical dimension.

In the above aspect, preferably, the second recessed part 102 includes a side extension part 104 that extends more outward than a corresponding position of an outer edge of the first recessed part 100 and directly communicates with the coolant discharge flow path PA6.

According to this aspect, and the bubbles smoothly move from the coolant discharge flow path PA6 to the second recessed part 102 without receiving a large flow resistance.

In the above aspect, preferably, the rear end receiving part 98 is positioned in an upper portion of the coolant discharge flow path PA6.

According to this aspect, the bubbles in the cooling medium are favorably captured in the rear end receiving part 98.

In the above aspect, preferably, the dry-side end unit 18 includes a terminal plate 60, an electrical insulation plate 62, and an end plate 64 in order from the side of the cell stack body 14, the electrical insulation plate 62 has the rea end receiving part 98 (the end portion receiving part), and the terminal plate 60 a support hole 86 through which the tube body 80 extends and an opening part 73A that opens the and the second recessed part 102 toward the coolant discharge flow path PA6.

According to this aspect, the bubbles smoothly flow from the coolant discharge flow path PA6 to the second recessed part 102.

In the above aspect, preferably, the support hole 86 is larger than the outer diameter R1 (outer dimension) of the tube body 80.

According to this aspect, the tube body 80 is supported by the terminal plate 60 to be displaceable in the stacking direction of the cell stack body 14 and the radial direction.

1. A fuel cell stack, comprising:
a cell stack body composed of multiple power generation cells stacked in a predetermined direction;
a first end unit and a second end unit respectively disposed at both ends of the cell stack body in a stacking direction thereof;
a cooling medium flow path including a cooling medium discharge flow path extending through the cell stack body in the stacking direction of the cell stack body to discharge a cooling medium supplied to the cell stack body to an outside; and
a tube body disposed in the cooling medium discharge flow path to extend in the stacking direction of the cell stack body, having end portions supported by the first end unit and the second end unit, and including an internal passage having openings at both ends,
wherein the second end unit includes an end portion receiving part for receiving a corresponding end portion of the tube body, and
the end portion receiving part comprises:
a first recessed part that is recessed in a direction away from the cell stack body and is open toward the cell stack body, the first recessed part receiving the corresponding end portion of the tube body to be displaceable in the stacking direction of the cell stack body and a direction perpendicular to the stacking direction and provided with a first wall surface that an end surface of the tube body can contact; and
a second recessed part that is recessed from a part of the first wall surface in a same direction as the first recessed part, opens in the first wall surface with an area smaller than an end area of the corresponding end portion of the tube body, and communicates with the internal passage of the tube body.

2. The fuel cell stack according to claim 1, wherein a vertical dimension of the first wall surface is smaller than a vertical dimension of the internal passage, and a vertical dimension of the second recessed part is smaller than a vertical dimension of the tube body.

3. The fuel cell stack according to claim 1, wherein the second recessed part is provided in an upper portion of the first recessed part.

4. The fuel cell stack according to claim 1, wherein the tube body has a cylindrical shape, and
the first wall surface has a planar shape that is substantially semicircular or substantially crescent-shaped in a substantially lower half of the first recessed part.

5. The fuel cell stack according to claim 1, wherein the second recessed part includes a side extension part that extends more outward than a corresponding position of an outer edge of the first recessed part and directly communicates with the cooling medium discharge flow path.

6. The fuel cell stack according to claim 1, wherein the end portion receiving part is positioned in an upper portion of the cooling medium discharge flow path.

7. The fuel cell stack according to claim 1, wherein the second end unit includes a terminal plate, an electrical insulation plate, and an end plate in order from a side of the cell stack body,
the electrical insulation plate has the end portion receiving part, and
the terminal plate has a support hole through which the tube body extends and an opening part that opens the second recessed part toward the cooling medium discharge flow path.

8. The fuel cell stack according to claim 7, wherein the support hole is larger than an outer dimension of the tube body.
